(19) United States
(12) Patent Application Publication
(10) Pub. No.: US 2015/0358964 A1
(43) Pub. Date: Dec. 10, 2015

(54) TIME-DIVISION DUPLEXING

(71) Applicant: NOKIA SOLUTIONS AND NETWORKS OY, Espoo (FI)

(72) Inventors: Esa Tapani TIIROLA, Kempele (FI); Kari Pekka PAJUKOSKI, Oulu (FI); Eeva LAHETKANGAS, Oulu (FI)

(21) Appl. No.: 14/763,060

(22) PCT Filed: Feb. 7, 2013
(86) PCT No.: PCT/EP2013/052376

§ 371 Date: Jul. 23, 2015

(51) Int. Cl. H04W 72/04; H04L 5/00; H04L 5/14; H04B 7/26

(52) U.S. Cl. CPC H04W 72/0446; H04W 72/0413; H04B 7/2656; H04L 5/0007; H04L 5/14

(57) ABSTRACT

A technique, including: controlling a radio transceiver to make and receive transmissions according to a radio frame structure that includes consecutive time frames of a predefined duration, wherein each time frame includes a plurality of consecutive sub-frames of a predefined duration, and each sub-frame includes a plurality of sets of time resources, and wherein the plurality of sets of time resources of a sub-frame includes: a first set useable for transmissions in a first direction; a second set useable for transmissions in a second, opposite direction; and a third set that is switchable between transmissions in the first direction and transmissions in the second direction, independently of the first and second sets of time resources in the same sub-frame and independently of other sub-frames in the same radio frame.

The technique of time-division duplexing is one technique for achieving bi-directional radio communications.

One time-division duplexing technique is described at 3GPP TS 36.211 V.10.4 and involves a radio frame structure comprising radio frames divided into sub-frames, wherein the whole of each of almost all the sub-frames is dedicated to either uplink or downlink transmissions according to a selected one of a limited number of configurations.

There has been identified the challenge of providing a time-division duplexing technique that is better able to cope with the expected future demands for communication systems. One aim of the inventors is to meet this challenge.

There is hereby provided a method, comprising: controlling a radio transceiver to make and receive transmissions according to a radio frame structure comprising consecutive time frames of a predefined duration, wherein each time frame comprises a plurality of consecutive sub-frames of a predefined duration, and each sub-frame comprises a plurality of sets of time resources, and wherein said plurality of sets of time resources of a sub-frame includes: a first set useable for transmissions in a first direction; a second set useable for transmissions in a second direction; and a third set that is switchable between transmissions in said first direction and transmissions in said second, opposite direction, independently of said first and second sets of time resources in the same sub-frame and independently of other sub-frames in the same radio frame.

According to one embodiment, the method further comprises controlling said radio transceiver to: transmit or receive data via said third set of time resources; transmit control information via one of said first and second set of time resources; and receive control information via the other of said first and second sets of time resources.

According to one embodiment, said control information comprises one or more of the following: reference signals; feedback about received transmissions; and scheduling information.

According to one embodiment, the method further comprises controlling said radio transceiver to: transmit or receive data via said third set of time resources; and transmit or receive via said first or second set of time resources feedback information about data transmissions.

According to one embodiment, said feedback information comprises transmission control protocol acknowledgements.

According to one embodiment, said first, second and third sets of time resources are located at respective, predetermined parts of the sub-frame, and have respective, predetermined durations.

According to one embodiment, said plurality of sub-frames includes a guard period between each adjacent pair of said first, second and third sets of time resources.

According to one embodiment, the first, second and third sets of time resources for said radio transceiver are aligned with the first, second and third sets of time resources for one or more neighbouring radio transceivers.

According to one embodiment, the method further comprises coordinating switching of said third set of resources for said radio transceiver and switching of said third set of resources for said one or more neighbouring radio transceivers.

According to one embodiment, the method further comprises: cancelling or mitigating interference between transmissions via said third set of time resources to or from said transceiver and transmissions via said third set of time resources to or from said one or more neighbouring transceivers.

According to one embodiment, said first and second sets of time resources of a sub-frame precede said third set of time resources of the same sub-frame.

According to one embodiment, said radio transceiver is located at a base station.

According to one embodiment, said radio transceiver is located at a communication device.

According to one embodiment, said third set of time resources of a sub-frame are longer than the sum of said first and second sets of time resources of the same sub-frame.

According to one embodiment, said third set of time resources of a sub-frame is at least 5 times longer than the sum of said first and second sets of time resources of the same sub-frame.

According to one embodiment, said sub-frames each have a predefined duration of no more than 0.25 ms.

There is also hereby provided an apparatus comprising: a processor and memory including computer program code, wherein the memory and computer program code are configured to, with the processor, cause the apparatus to: control a radio transceiver to make and receive transmissions according to a radio frame structure comprising consecutive time frames of a predefined duration, wherein each time frame comprises a plurality of consecutive sub-frames of a predefined duration, and each sub-frame comprises a plurality of sets of time resources, and wherein said plurality of sets of time resources of a sub-frame includes: a first set useable for transmissions in a first direction; a second set useable for transmissions in a second, opposite direction; and a third set that is switchable between transmissions in said first direction and transmissions in said second direction, independently of said first and second sets of time resources in the same sub-frame and independently of other sub-frames in the same radio frame.

According to one embodiment, the memory and computer program code are further configured to, with the processor, cause the apparatus to: control said radio transceiver to: transmit or receive data via said third set of time resources; transmit control information via one of said first and second set of time resources; and receive control information via the other of said first and second sets of time resources.

According to one embodiment, said control information comprises one or more of the following: reference signals; feedback about received transmissions; and scheduling information.

According to one embodiment, the memory and computer program code are further configured to, with the processor, cause the apparatus to: control said radio transceiver to: transmit or receive data via said third set of time resources; and transmit or receive via said first or second set of time resources feedback information about data transmissions.

According to one embodiment, said feedback information comprises transmission control protocol acknowledgements.

According to one embodiment, said first, second and third sets of time resources are located at respective, predetermined parts of the sub-frame, and have respective, predetermined durations.

According to one embodiment, said plurality of sub-frames includes a guard period between each adjacent pair of said first, second and third sets of time resources.

According to one embodiment, the first, second and third sets of time resources for said radio transceiver are aligned with the first, second and third sets of time resources for one or more neighbouring radio transceivers.

According to one embodiment, the memory and computer program code are further configured to, with the processor, cause the apparatus to: coordinate switching of said third set of resources for said radio transceiver and switching of said third set of resources for said one or more neighbouring radio transceivers.

According to one embodiment, the memory and computer program code are further configured to, with the processor, cause the apparatus to: cancel or mitigate interference between transmissions via said third set of time resources to or from said transceiver and transmissions via said third set of time resources to or from said one or more neighbouring transceivers.

According to one embodiment, said first and second sets of time resources of a sub-frame precede said third set of time resources of the same sub-frame.

According to one embodiment, said radio transceiver is located at a base station.

According to one embodiment, said radio transceiver is located at a communication device.

According to one embodiment, said third set of time resources of a sub-frame are longer than the sum of said first and second sets of time resources of the same sub-frame.

According to one embodiment, said third set of time resources of a sub-frame is at least 5 times longer than the sum of said first and second sets of time resources of the same sub-frame.

According to one embodiment, said sub-frames each have a predefined duration of no more than 0.25 ms.

There is also hereby provided an apparatus comprising: means for controlling a radio transceiver to make and receive transmissions according to a radio frame structure comprising consecutive time frames of a predefined duration, wherein each time frame comprises a plurality of consecutive sub-frames of a predefined duration, and each sub-frame comprises a plurality of sets of time resources, and wherein said plurality of sets of time resources of a sub-frame includes: a first set useable for transmissions in a first direction; a second set useable for transmissions in a second, opposite direction; and a third set that is switchable between transmissions in said first direction and transmissions in said second direction, independently of said first and second sets of time resources in the same sub-frame and independently of other sub-frames in the same radio frame.

There is also hereby provided a computer program product comprising program code means which when loaded into a computer controls the computer to: control a radio transceiver to make and receive transmissions according to a radio frame structure comprising consecutive time frames of a predefined duration, wherein each time frame comprises a plurality of consecutive sub-frames of a predefined duration, and each sub-frame comprises a plurality of sets of time resources, and wherein said plurality of sets of time resources of a sub-frame includes: a first set useable for transmissions in a first direction; a second set useable for transmissions in a second, opposite direction; and a third set that is switchable between transmissions in said first direction and transmissions in said second direction, independently of said first and second sets of time resources in the same sub-frame and independently of other sub-frames in the same radio frame.

Embodiments of the present invention are described in detail hereunder, by way of example only, with reference to the accompanying drawings, in which:

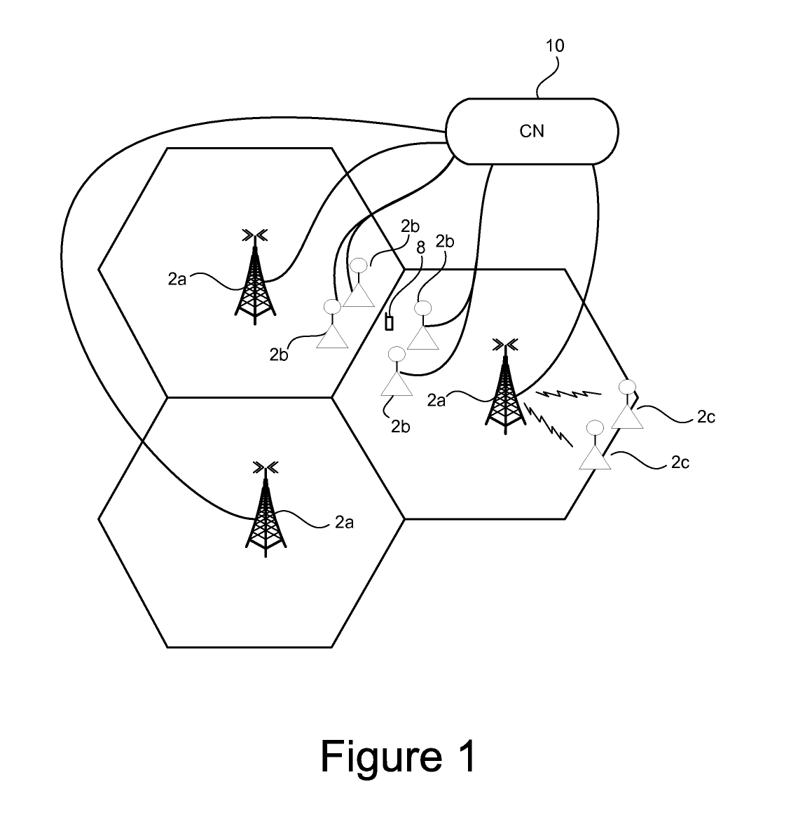

FIG. 1 illustrates an example of a network of base stations in which an embodiment of the present invention is implemented;

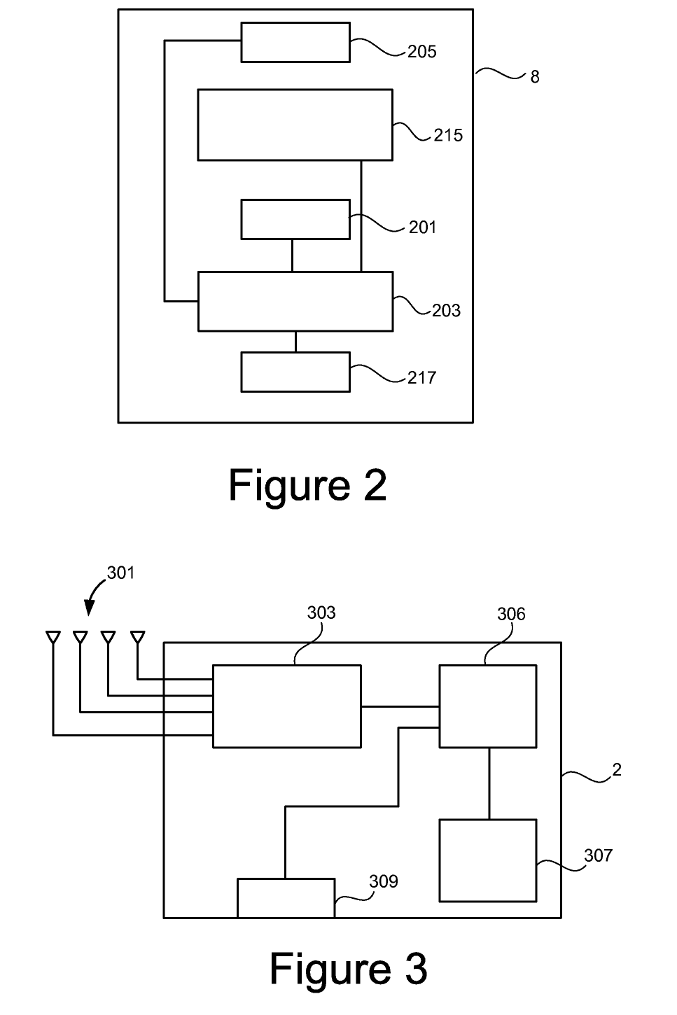

FIG. 2 illustrates an example of apparatus for use at user equipment (UE) in FIG. 1;

FIG. 3 illustrates an example of apparatus for use at the base stations in FIG. 1;

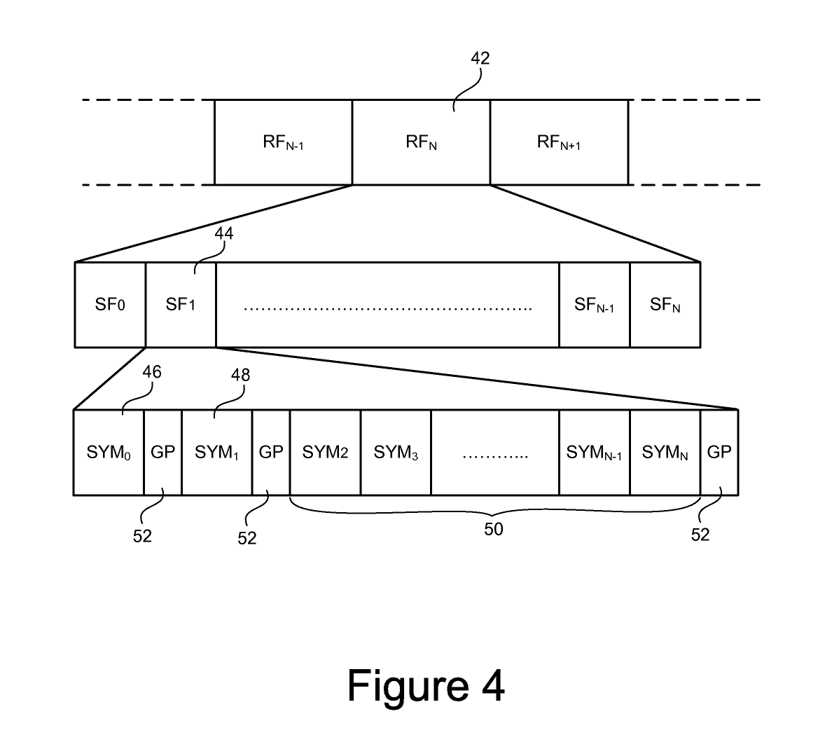

FIG. 4 illustrates an example of a sub-frame structure used in a technique according to an embodiment of the present invention;

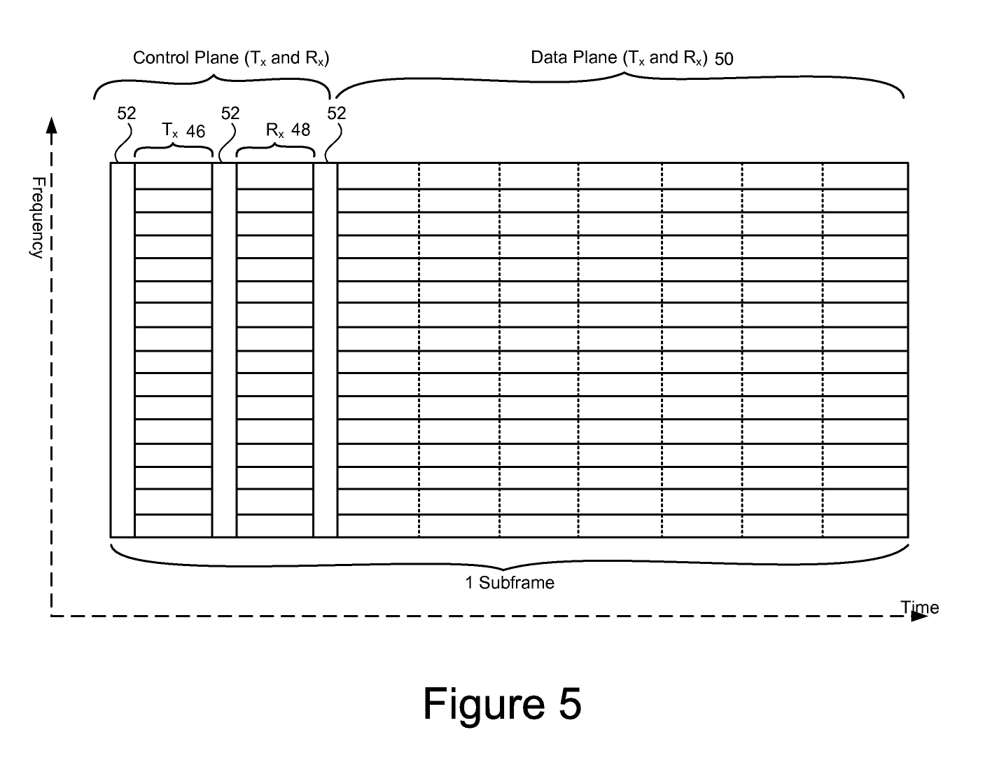

FIG. 5 illustrates the sub-frame structure of FIG. 4 in the context of a LTE system operating according to OFDM; and

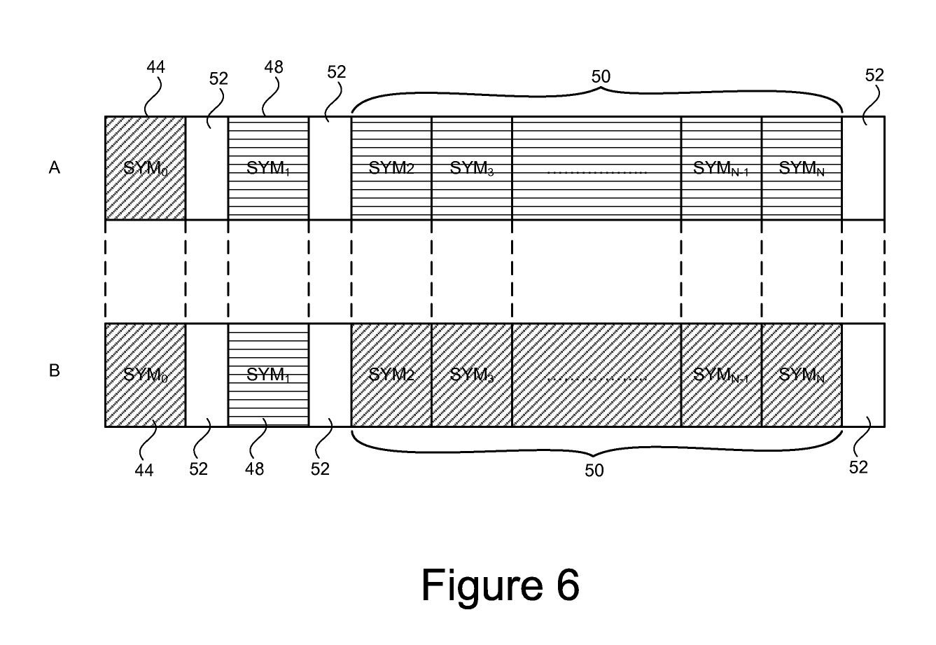

FIG. 6 illustrates the alignment of symbol transmissions between two cells in a technique according to an embodiment of the present invention.

A technique according to an embodiment of the invention is described in detail below, by way of example only, in the context of OFDM (Orthogonal Frequency Division Multiplexing) transmissions between local area (LA) base stations and communication devices in an LTE (Long Term Evolution) heterogeneous network.

The heterogeneous network illustrated in FIG. 1 comprises base stations 2 referred to as eNodeBs (eNBs) 2. The eNBs 2 comprise high power (macro) base stations 2a supported by low-power (local area) base stations 2b, 2c. The base stations of the network are all connected to a core network (CN) 10 either via a wired connection (base stations 2a and 2b) or via another of the base stations and a radio link (backhaul link) with that base station. The latter are referred to as relay nodes 2c.

Only three macro base stations 2a are shown in FIG. 1, but a network would typically comprise thousands of macro base stations. Similarly, only six local area base stations 2b, 2c are shown in FIG. 1, but a network would typically comprise a large number of local area base stations, particularly at the edges of the cells operated by the macro base stations 2a and/or in areas of high traffic density (hot spots), such as shopping centres or office buildings. Each base station 2 operates one or more cells. The coverage area of each cell depends on the transmission power and the directionality of the antenna by which the cell is operated.

Because, local area (LA) base stations 2b, 2c are of relatively low power, the transmissions between LA base stations and UEs 8 are characterised by relatively small variations in propagation delay.

FIG. 2 shows a schematic view of an example of user equipment 8 that may be used for communicating with the base stations 2 of FIG. 1 via a wireless interface. The user equipment (UE) 8 may be used for various tasks such as making and receiving phone calls, for receiving and sending data from and to a data network and for experiencing, for example, multimedia or other content.

The UE 8 may be any device capable of at least sending or receiving radio signals to or from the base stations 2 of FIG. 1. The UE 8 may also, for example, be capable of transmitting and receiving radio signals to and from another UE directly (i.e. other than via a base station or other kind of transceiver). Non-limiting examples include a mobile station (MS), a portable computer provided with a wireless interface card or other wireless interface facility, personal data assistant (PDA) provided with wireless communication capabilities, or any combinations of these or the like. The UE 8 may communicate via an appropriate radio interface arrangement 205 of the UE 8. The interface arrangement may be provided for example by means of a radio part and associated antenna arrangement. The antenna arrangement may be arranged internally or externally to the UE 8.

The UE 8 may be provided with at least one data processing entity 203 and at least one memory or data storage entity 217 for use in tasks it is designed to perform. The data processor 213 and memory 217 may be provided on an appropriate circuit board and/or in chipsets.

The user may control the operation of the UE 8 by means of a suitable user interface such as key pad 201, voice commands, touch sensitive screen or pad, combinations thereof or the like. A display 215, a speaker and a microphone may also be provided. Furthermore, the UE 8 may comprise appropriate connectors (either wired or wireless) to other devices and/or for connecting external accessories, for example hands-free equipment, thereto.

FIG. 3 shows an example of apparatus for use at the base stations 2 of FIG. 1. The apparatus comprises a radio frequency antenna array 301 configured to receive and transmit radio frequency signals; radio frequency interface circuitry 303 configured to interface the radio frequency signals received and transmitted by the antenna 301 and the data processor 306. The radio frequency interface circuitry 303 may also be known as a transceiver. The apparatus also comprises an interface 309 via which, for example, it can communicate with other network elements such as the core network 10. The data processor 306 is configured to process signals from the radio frequency interface circuitry 303, control the radio frequency interface circuitry 303 to generate suitable RF signals to communicate information to the UE 8 via the wireless communications link, and also to exchange information with other network nodes via the interface 309. The memory 307 is used for storing data, parameters and instructions for use by the data processor 306.

It would be appreciated that the apparatus shown in each of FIGS. 2 and 3 described above may comprise further elements which are not directly involved with the embodiments of the invention described hereafter.

According to one embodiment of the present invention illustrated in FIG. 4, the time resources for transmissions in the network are divided into consecutive radio frames 42 of predefined duration; each radio frame 42 is divided into N sub-frames 44 of predefined duration; and each sub-frame 44 is divided into three sets of time resources 46, 48, 50 of predefined duration, which are each independently switchable between downlink and uplink transmissions (or from the point of view of a single transceiver, they are each independently switchable between transmitting time resources and receiving time resources).

In one example: it is predetermined that each cell of the network uses the first relatively short set 46 of the three sets of time resources of each sub-frame for the downlink transmission of control information (e.g. transmissions of control information made by a LA base station 2b of the cell), and the other relatively short set 48 of time resources of each sub-frame for the uplink transmission of control information (e.g. transmissions of control information to a LA base station 2b of the cell); whereas each cell can choose to use the relatively long set 50 of time resources of each sub-frame for either uplink transmissions or downlink transmissions of data, which choice can be made by the cell independently of the choice made for other sub-frames in the same radio frame.

The relatively short sets of time resources 46 and 48 used for the transmission of control information in this example can also each have a duration longer than the illustrated example of 1 symbol duration.

Configuring the two short sets of time resources 46, 48 to have equal duration can have the advantage of facilitating: (a) efficient cell and device discovery with various discovery patterns; (b) link independent multiple access; and (c) support for link types such as wireless backhaul and D2D. However, it is also possible for these two relatively short sets of time resources 46, 48 to be configured to have different durations.

Transmitting control information (both uplink and downlink control information) via the pair of sets of time resources 46, 48 closest to the start of the sub-frame (i.e. both before the longer set of time resources 50 used for the transmission of data) has the advantage that there is an opportunity to communicate both downlink and uplink control information at the start of the sub-frame 44, which can facilitate fast and cost-efficient pipeline processing at the receiver of data transmitted via the longer set of time resources 50. However, other arrangements of the three sets of time resources 46, 48, 50 within the sub-frame 44 are also possible.

FIG. 5 illustrates the sub-frame structure of FIG. 4 for the example of OFDM transmissions. Each row in FIG. 5 represents a respective sub-band. Only 16 sub-bands are shown in FIG. 5, but this is only for the illustration purpose. The number of sub-bands is not limited by any means. Each sub-band involves a predefined number of OFDM sub-carriers. Transmissions between a local area base station and a plurality of UEs will typically occur in the same sub-frame by making use of respective sets of frequency resources (respective sets of OFDM sub-bands/sub-carriers).

The control information transmitted via the relatively short sets of time resources 46, 48 may include: reference signals, data-associated control information such as HARQ (Hybrid Automatic Repeat Request) feedback about one or more transmissions made via one or more past sub-frames, information about the scheduling of data transmissions; and feedback information associated with data protocols such as TCP (Transmission Control Protocol) acknowledgements.

Each of the three sets of time resources 46, 48, 50 is separated from the sets of time resources that immediately precede and follow it (either in the same sub-frame or in the previous or next sub-frame) by a guard period 52. The provision of three guard periods between each and every pair of adjacent sets of time resources 46, 48, 50 in this example is designed to ensure that the sub-frame structure can provide good symbol alignment (signal timing alignment) between receivers for different types of links, including: direct wireless links between two UEs (Device to Device (D2D) links); wireless links between base stations (Access Point to Access Point (AP2AP) links), as well as links between a base station 2 and a UE 8, regardless of the direction of transmission via the relatively long set of time resources 50. For the example of transmissions between a local area base station 2b and a UE 8, the guard periods 52 (particular the two guard periods that separate the long set of time resources 50 used for data transmission in this example, and the preceding/following shorter sets of time resources 46, 48) facilitate good symbol timing at receivers in overlapping cells operated by respective LA base stations 2b, even if one cell is using the longer set 50 of time resources of a particular sub-frame for uplink transmissions, and an adjacent, overlapping cell is using the same longer set of time resources of the same sub-frame for downlink transmissions, as illustrated in FIG. 6. In FIG. 6, the diagonally hatched time resources indicate downlink transmissions and the horizontally hatched time resources indicate uplink transmissions. Good signal timing alignment between cells facilitates efficient cross-link interference mitigation at receivers (of both base stations and UEs). According to one example, the guard periods are designed such that signal timing alignment can be guaranteed between radio transceivers whose links to UEs are characterised by short propagation delays (such as between local area base stations), even if a Timing Advance procedure is not applied (providing that care is taken to ensure that uplink transmissions arrive at the base stations (eNodeB) essentially within the duration of the cyclic prefix).

As mentioned above, the provision of three guard periods (particularly the guard period between the two short sets of time resources located at the start of the sub-frame) facilitates a different use of these sets of time resources to the one described above, such as using both short sets of time resources for the transmission of control information in the same direction. Examples of links for which such flexibility can be particularly useful are D2D and AP2AP links.

In one specific example: (i) the sub-frame 44 has a predefined duration of 0.25 ms; (ii) the two short sets of time resources 46, 48 each have a predefined duration corresponding to 1 OFDM symbol for a OFDM sub-carrier spacing of 60 kHz; (iii) the long set of time resources 50 has a predefined duration corresponding to 12 OFDM symbols for a OFDM sub-carrier spacing of 60 kHz, wherein the duration for 1 OFDM symbol is defined by the sum of (a) a 1 microsecond cyclic prefix (CP) and (b) the inverse of the OFDM sub-carrier spacing (1/60 ms in the case of a 60 kHz sub-carrier spacing); and (iv) the guard periods each have a predefined duration of 0.89 microseconds.

One advantageous feature of the embodiment described above is that it supports e.g. (i) fast and robust control signalling, (ii) low HARQ Round Trip Time RTT; and (iii) low HARQ buffers, whilst at the same time facilitating (iv) high flexibility of allocation of time resources between uplink and downlink transmissions in quick response to traffic load changes of the kind that can often occur particularly in communications involving local area base stations. For example, the traffic to and from local area base stations can be bursty and asymmetric as a result of e.g. local file sharing and high proportions of internet traffic. For example, if local file sharing between UEs takes place via a base station, then a level of UL traffic demand at a particular instant of time can be much higher than the level of DL traffic demand at the same instant of time.

The HARQ RTT mentioned above is the length of time between the transmission of a data packet and the time at which the next data packet can be sent, wherein the next data packet can only be transmitted after receiving positive HARQ acknowledgment ACK for the preceding data packet.

In the embodiment described above, the frequency at which control information for both uplink and downlink directions can be transmitted (i.e. once per sub-frame) is twice the maximum frequency at which data can be transmitted in both uplink and downlink directions (i.e. once per two sub-frames, because each sub-frame only includes data for one direction). This feature facilitates the frequent transmission of important uplink and downlink control information (such as HARQ feedback and resource request), even if the data transmissions are predominantly occurring in one direction.

The above-mentioned advantageous features are expected to be particularly useful for Beyond 4G (B4G) radio systems.

An embodiment has been described above for the example of controlling the operation of a radio transceiver from a base station, but the same kind of technique is also applicable to controlling the operation of a radio transceiver from any network entity, such as e.g. a host or a server.

The above-described operations may require data processing in the various entities. The data processing may be provided by means of one or more data processors. Similarly various entities described in the above embodiments may be implemented within a single or a plurality of data processing entities and/or data processors.

The embodiments of the invention may be implemented as at least one software application, module or unit configured as arithmetic operation, or as a program (including an added or updated software routine), executed by at least one operation processor. Programs, also called program products or computer programs, including software routines, applets and macros, may be stored in any apparatus-readable non-transitory data storage medium and they include program instructions to perform particular tasks. Computer programs may be coded by a programming language, which may be a high-level programming language, such as objective-C, C, C++, C#, Java, etc., or a low-level programming language, such as a machine language, or an assembler.

For example the embodiments of the invention may be implemented as a chipset, in other words a series of integrated circuits communicating among each other.

The chipset may comprise microprocessors arranged to run code, application specific integrated circuits (ASICs), or programmable digital signal processors for performing the operations described above.

Embodiments of the invention may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

In addition to the modifications explicitly mentioned above, it will be evident to a person skilled in the art that various other modifications of the described embodiment may be made within the scope of the invention.

1. A method, comprising:
controlling a radio transceiver to make and receive transmissions according to a radio frame structure that includes consecutive time frames of a predefined duration, wherein each time frame includes a plurality of consecutive sub-frames of a predefined duration, and each sub-frame includes a plurality of sets of time resources, and wherein said plurality of sets of time resources of a sub-frame includes: a first set useable for transmissions in a first direction; a second set useable for transmissions in a second, opposite direction; and a third set that is switchable between transmissions in the first direction and transmissions in the second direction, independently of the first and second sets of time resources in the same sub-frame and independently of other sub-frames in the same radio frame.

2. A method according to claim 1, further comprising controlling the radio transceiver to:
transmit or receive data via the third set of time resources;
transmit control information via one of the first set and the second set of time resources; and
receive control information via the other of the first and second sets of time resources.

3. A method according to claim 2, wherein the control information comprises one or more of the following:
reference signals;
feedback about received transmissions; and
scheduling information.

4. A method according to claim 1, further comprising controlling the radio transceiver to:
transmit or receive data via the third set of time resources; and
transmit or receive via the first set or the second set of time resources feedback information about data transmissions.

5. A method according to claim 4, wherein the feedback information comprises transmission control protocol acknowledgements.

6. A method according to claim 1, wherein the first, second and third sets of time resources are located at respective, predetermined parts of the sub-frame, and have respective, predetermined durations.

7. A method according to claim 1, wherein the plurality of sub-frames includes a guard period between each adjacent pair of said first, second and third sets of time resources.

8. A method according to claim 1, wherein the first, second and third sets of time resources for the radio transceiver are aligned with the first, second and third sets of time resources for one or more neighbouring radio transceivers.

9. A method according to claim 8, comprising coordinating switching of the third set of resources for said radio transceiver and switching of the third set of resources for the one or more neighbouring radio transceivers.

10. A method according to claim 9, further comprising:
cancelling or mitigating interference between transmissions via the third set of time resources to or from the transceiver and transmissions via the third set of time resources to or from the one or more neighbouring transceivers.

11. A method according to claim 1, wherein the first and second sets of time resources of a sub-frame precede the third set of time resources of the same sub-frame.

12. A method according to claim 1, wherein the radio transceiver is located at a base station.

13. A method according to claim 1, wherein the radio transceiver is located at a communication device.

14. A method according to claim 1, wherein the third set of time resources of a sub-frame are longer than the sum of the first and second sets of time resources of the same sub-frame.

15. A method according to claim 14, wherein the third set of time resources of a sub-frame is at least 5 times longer than the sum of the first and second sets of time resources of the same sub-frame.

16. A method according to claim 1, wherein the sub-frames each have a predefined duration of no more than 0.25 ms.

17. An apparatus comprising a processor and memory including computer program code, wherein the memory and computer program code are configured to, with the processor, cause the apparatus to:
control a radio transceiver to make and receive transmissions according to a radio frame structure comprising consecutive time frames of a predefined duration, wherein each time frame comprises a plurality of consecutive sub-frames of a predefined duration, and each sub-frame comprises a plurality of sets of time resources, and wherein said plurality of sets of time resources of a sub-frame includes: a first set useable for transmissions in a first direction; a second set useable for transmissions in a second, opposite direction; and a third set that is switchable between transmissions in said first direction and transmissions in said second direction, independently of said first and second sets of time resources in the same sub-frame and independently of other sub-frames in the same radio frame.

18. An apparatus according to claim 17, wherein the memory and computer program code are further configured to, with the processor, cause the apparatus to:
control said radio transceiver to:
transmit or receive data via said third set of time resources; and
transmit control information via one of said first and second set of time resources; and receive control information via the other of said first and second sets of time resources.

19. An apparatus according to claim 18, wherein the control information comprises one or more of the following:
reference signals;
feedback about received transmissions; and
scheduling information.

20. An apparatus according to claim 17, wherein the memory and computer program code are further configured to, with the processor, cause the apparatus to:
control said radio transceiver to:
transmit or receive data via said third set of time resources; and
transmit or receive via said first or second set of time resources feedback information about data transmissions.

21. An apparatus according to claim 20, wherein the feedback information comprises transmission control protocol acknowledgements

22. An apparatus according to claim 17, wherein the first, second and third sets of time resources are located at respective, predetermined parts of the sub-frame, and have respective, predetermined durations.

23. An apparatus according to claim 17, wherein the plurality of sub-frames includes a guard period between each adjacent pair of said first, second and third sets of time resources.

24. An apparatus according to claim 17, wherein the first, second and third sets of time resources for the radio transceiver are aligned with the first, second and third sets of time resources for one or more neighbouring radio transceivers.

25. An apparatus according to claim 24, wherein the memory and computer program code are further configured to, with the processor, cause the apparatus to:
coordinate switching of the third set of resources for the radio transceiver and switching of the third set of resources for the one or more neighbouring radio transceivers.

26. An apparatus according to claim 25, wherein the memory and computer program code are further configured to, with the processor, cause the apparatus to:
cancel or mitigate interference between transmissions via the third set of time resources to or from the transceiver and transmissions via the third set of time resources to or from the one or more neighbouring transceivers.

27. An apparatus according to claim 17, wherein the first and second sets of time resources of a sub-frame precede the third set of time resources of the same sub-frame.

28. An apparatus according to claim 17, wherein the radio transceiver is located at a base station.

29. An apparatus according to claim 17, wherein the radio transceiver is located at a communication device.

30. An apparatus according to claim 17, wherein the third set of time resources of a sub-frame are longer than the sum of the first and second sets of time resources of the same sub-frame.

31. An apparatus according to claim 30, wherein the third set of time resources of a sub-frame is at least 5 times longer than the sum of the first and second sets of time resources of the same sub-frame.

32. An apparatus according to claim 17, wherein the sub-frames each have a predefined duration of no more than 0.25 ms.

33. (canceled)

34. A computer program product comprising program code which when executed by a processor causes the processor to:
control a radio transceiver to send and receive transmissions according to a radio frame structure comprising consecutive time frames of a predefined duration, wherein each time frame includes a plurality of consecutive sub-frames of a predefined duration, and each sub-frame includes a plurality of sets of time resources, and wherein the plurality of sets of time resources of a sub-frame includes:
a first set useable for transmissions in a first direction;
a second set useable for transmissions in a second, opposite direction; and
a third set that is switchable between transmissions in the first direction and transmissions in the second direction, independently of the first and second sets of time resources in the same sub-frame and independently of other sub-frames in the same radio frame.
